(19) United States
(12) Patent Application Publication
(10) Pub. No.: US 2015/0260061 A1
(43) Pub. Date: Sep. 17, 2015

(54) FLUID PUMP ASSEMBLY FOR AN INTERNAL COMBUSTION ENGINE

(71) Applicant: GM GLOBAL TECHNOLOGY OPERATIONS LLC, Detroit, MI (US)

(72) Inventors: Antonino CONTI, Torino (IT); Pierluigi PAGLIARO, Torino (IT)

(73) Assignee: GM GLOBAL TECHNOLOGY OPERATIONS LLC, Detroit, MI (US)

(21) Appl. No.: 14/656,215

(22) Filed: Mar. 12, 2015

(30) Foreign Application Priority Data
Mar. 14, 2014 (GB) 1404689.0

(51) Int. Cl. F01M 1/02; F02M 59/00; F16C 3/10; F01M 11/00; F02M 63/02; F02M 37/06

(52) U.S. Cl. CPC F01M 1/02; F02M 63/0265; F02M 37/06; F16C 3/10; F01M 11/0004; F02M 59/00; F01M 2001/0284; F01M 2001/0269; F01M 2011/0079

(57) ABSTRACT

A fluid pump assembly for an internal combustion engine is disclosed. The fuel pump assembly is equipped with a pumping plunger for pressurizing fluid. The pumping plunger being driven by a cam press fitted or keyed on a crankshaft of an internal combustion engine.

### CROSS-REFERENCE TO RELATED APPLICATION

This application claims priority to Great Britain Patent Application No. 1404689.0, filed Mar. 14, 2014, which is incorporated herein by reference in its entirety.

### TECHNICAL FIELD

This application pertains to a fluid pump assembly for an internal combustion engine. The fluid pump assembly may be used in a fuel injection application, oil sump application or other fluid pumping situations associated with an internal combustion engine.

### BACKGROUND

An internal combustion engine (ICE) for a motor vehicle generally includes an engine block which defines at least one cylinder accommodating a reciprocating piston coupled to rotate a crankshaft. The cylinder is closed by a cylinder head that cooperates with the reciprocating piston to define a combustion chamber. A fuel and air mixture is cyclically disposed in the combustion chamber and ignited, thereby generating hot expanding exhaust gasses that cause the reciprocating movements of the piston. The fuel is injected into each cylinder by a respective fuel injector. The fuel is provided at high pressure to each fuel injector from a fuel rail in fluid communication with a high pressure fuel pump that increases the pressure of the fuel received from a fuel source.

The high pressure pump may be a so-called unit pump which includes a plunger that is driven for reciprocal movement within a bore provided in the pump housing by means of a cam drive arrangement. The cam drive arrangement generally includes a cam that is mounted on a camshaft of the engine. The cam rotating along with the camshaft cooperates with a cam follower, such as a roller, to deliver a pumping stroke of the plunger during which pressurizes the fuel. A return spring maintains the cam follower in contact with the cam profile.

The fact that the unit pump is positioned in such a way to be driven by the cam mounted on the camshaft creates a series of problems due to the fact that the unit pump absorbs more torque with respect to a conventional fuel pump, creating sensible dynamic disturbances or stresses on the timing-drive that synchronizes the rotation of the crankshaft and the camshaft(s) and on the valve-train system itself. Such unit pump assemblies also require an extra camshaft bearing to withstand this higher load.

Finally, the position of the unit pump assembly whereby the pump is driven by the camshaft makes it difficult to position the unit pump into the cylinder head.

### SUMMARY

A fluid pump assembly in accordance with the present disclosure overcomes the above mentioned problems and, in particular, eliminates the high dynamical stresses on the timing-drive and on the valve-train typical of the known assembly in a simple, rational and inexpensive solution.

An embodiment of the present disclosure provides a fluid pump assembly including a fluid pump equipped with a pumping plunger for pressurizing fluid. The pumping plunger is driven by a cam press fitted or keyed on the crankshaft. An advantage of this embodiment is that it makes it possible to downsize materials requirements and design dimension of valve-train and timing-drive components, allowing ultimately a CO₂ reduction. An embodiment may further include a crankshaft for an internal combustion engine including one engine cylinder equipped with a piston coupled to rotate the crankshaft, the crankshaft being equipped with a cam press fitted or keyed thereon.

According to an embodiment of the present disclosure, the fluid pump is a fuel unit pump for pressurizing fuel to be supplied to a fuel injector for injecting fuel into the cylinder. An advantage of the above embodiment is that it guarantees an improved reliability of the timing-drive system which is not subjected to dynamical stress caused by the presence of a fuel unit pump when driven by the camshaft.

Also in this case materials requirements and design dimensions of valve-train and timing-drive components can he downsized. For example, grey cast iron for the camshaft and an 8 mm pitch chain for a diesel engine may be used and, eventually, plastic gears for cam-to-cam transmission.

According to another embodiment of the present disclosure, the internal combustion engine is equipped with a fuel rail fluid communication with the fuel unit pump. An advantage of this embodiment is that it allows to increase significantly the fuel pressure, as may be needed according to the current market trend, without constrains from a timing-drive perspective.

According to another embodiment of the present disclosure, the fuel unit pump is located on an engine block of the internal combustion engine. An advantage of this embodiment is that it allows an easier packaging of the pump in the volume close to the crankshaft, since more space is available in that position.

According to another embodiment of the present disclosure, the fuel unit pump is located inside an oil sump of the internal combustion engine. An advantage of this embodiment is that it allows an alternative solution for packaging of the pump by exploiting available space inside the oil sump in order to obtain a more compact engine design.

According to a further embodiment of the present disclosure, the fluid pump is a hydraulic pump for pressurizing oil to be supplied to actuators associated to the engine.

According to still another embodiment of the present disclosure, the cam is a single lobed or a multi lobed cam. An advantage of this embodiment is that the cam may be dimensioned with the required number of lobes depending on the number of cylinders in the engine.

According to another embodiment of the present disclosure, the engine is a V-engine equipped with two fuel unit pumps disposed in opposite positions with respect to the cam. An advantage of this embodiment is that it uses the same cam to drive two unit pumps.

### BRIEF DESCRIPTION OF THE DRAWINGS

The present disclosure will hereinafter be described in conjunction with the following drawing figures, wherein like numerals denote like elements.

FIG. 1 shows an automotive system;

FIG. 2 is a cross-section of an internal combustion engine belonging to the automotive system of FIG. 1; and

FIG. 3 is a perspective view of a fuel pump assembly, according to an embodiment of the present disclosure;

FIGS. 4-5 are perspective views of fuel pump assemblies, according to additional embodiments of the present disclosure; and

FIG. 6 is a perspective view that represents various embodiments of the present disclosure in a single illustration.

### DETAILED DESCRIPTION OF THE DRAWINGS

The following detailed description is merely exemplary in nature and is not intended to limit the present disclosure or the application and uses of the present disclosure. Furthermore, there is no intention to be bound by any theory presented in the preceding background of the present disclosure or the following detailed description.

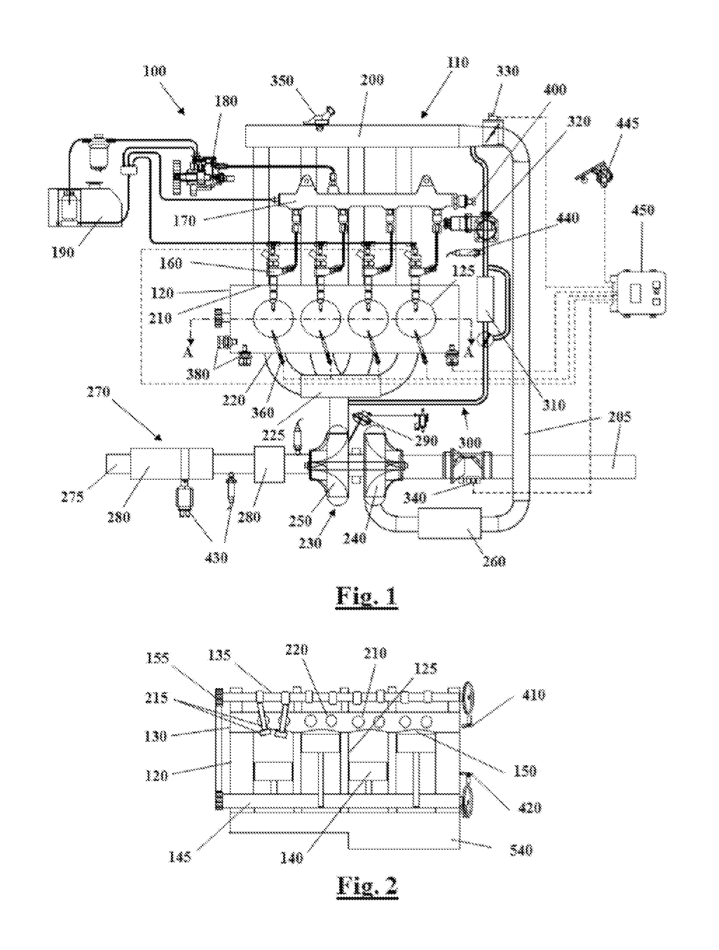

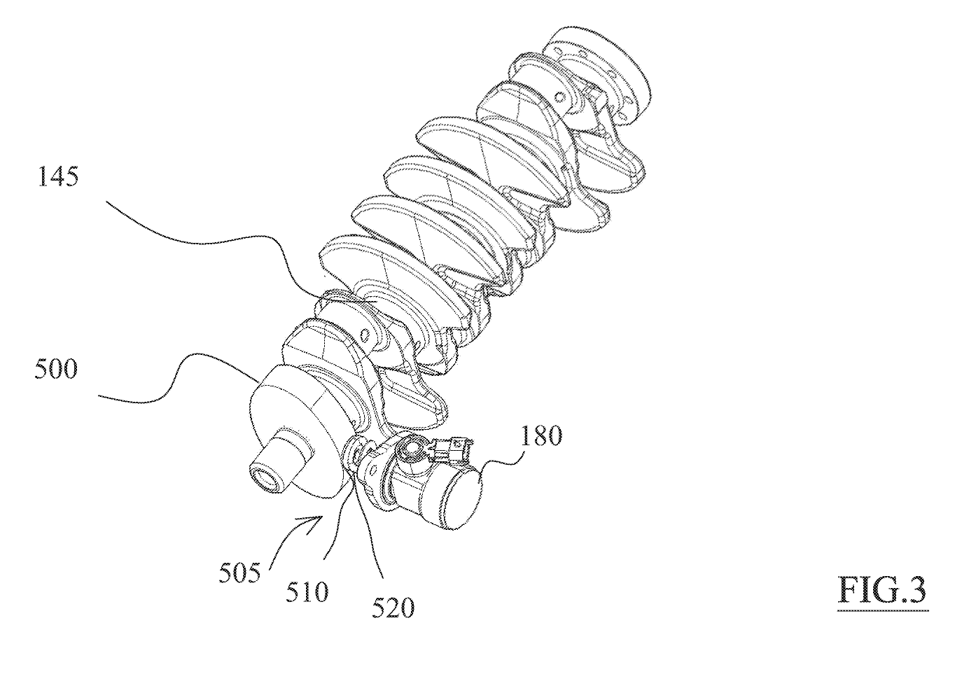

Some embodiments may include an automotive system 100, as shown in FIGS. 1 and 2, that includes an internal combustion engine (ICE) 110 having an engine block 120 defining at least one cylinder 125 having a piston 140 coupled to rotate a crankshaft 145. A cylinder head 130 cooperates with the piston 140 to define a combustion chamber 150. A fuel and air mixture (not shown) is disposed in the combustion chamber 150 and ignited, resulting in hot expanding exhaust gasses causing reciprocal movement of the piston 140. The fuel is provided by at least one fuel injector 160 and the air through at least one intake port 210. The fuel is provided at high pressure to the fuel injector 160 from a fuel rail 170 in fluid communication with a high pressure fuel pump 180 that increase the pressure of the fuel received a fuel source 190. Each of the cylinders 125 has at least two valves 215, actuated by a camshaft 135 rotating in time with the crankshaft 145. The valves 215 selectively allow air into the combustion chamber 150 from the port 210 and alternately allow exhaust gases to exit through a port 220. In some examples, a cam phaser 155 may selectively vary the timing between the camshaft 135 and the crankshaft 145.

The air may be distributed to the air intake port(s) 210 through an intake manifold 200. An air intake duct 205 may provide air from the ambient environment to the intake manifold 200. In other embodiments, a throttle body 330 may be provided to regulate the flow of air into the manifold 200. In still other embodiments, a forced air system such as a turbocharger 230, having a compressor 240 rotationally coupled to a turbine 250, may be provided. Rotation of the compressor 240 increases the pressure and temperature of the air in the duct 205 and manifold 200. An intercooler 260 disposed in the duct 205 may reduce the temperature of the air. The turbine 250 rotates by receiving exhaust gases from an exhaust manifold 225 that directs exhaust gases from the exhaust ports 220 and through a series of vanes prior to expansion through the turbine 250. The exhaust gases exit the turbine 250 and are directed into an exhaust system 270. This example shows a variable geometry turbine (VGT) with a VGT actuator 290 arranged to move the vanes to alter the flow of the exhaust gases through the turbine 250. In other embodiments, the turbocharger 230 may be fixed geometry and/or include a waste gate.

The exhaust system 270 may include an exhaust pipe 275 having one or more exhaust aftertreatment devices 280. The aftertreatment devices may be any device configured to change the composition of the exhaust gases. Some examples of aftertreatment devices 280 include, but are not limited to, catalytic converters (two and three way), oxidation catalysts, lean NOx traps, hydrocarbon adsorbers, selective catalytic reduction (SCR) systems, and particulate filters. Other embodiments may include an exhaust gas recirculation (EGR) system 300 coupled between the exhaust manifold 225 and the intake manifold 200. The EGR system 300 may include an EGR cooler 310 to reduce the temperature of the exhaust gases in the EGR system 300. An EGR valve 320 regulates a flow of exhaust gases in the EGR system 300.

The automotive system 100 may further include an electronic control unit (ECU) 450 in communication with one or more sensors and/or devices associated with the ICE 110. The ECU 450 may receive input signals from various sensors configured to generate the signals in proportion to various physical parameters associated with the ICE 110. The sensors include, but are not limited to, a mass airflow and temperature sensor 340, a manifold pressure and temperature sensor 350, a combustion pressure sensor 360, coolant and oil temperature and level sensors 380, a fuel rail pressure sensor 400, a cam position sensor 410, a crank position sensor 420, exhaust pressure and temperature sensors 430, an EGR temperature sensor 440, and an accelerator pedal position sensor 445. Furthermore, the ECU 450 may generate output signals to various control devices that are arranged to control the operation of the ICE 110, including, but not limited to, the fuel injectors 160, the throttle body 330, the EGR Valve 320, the VGT actuator 290, and the cam phaser 155. Note, dashed lines are used to indicate communication between the ECU 450 and the various sensors and devices, but some are omitted for clarity.

Turning now to the ECU 450, this apparatus may include a digital central processing unit (CPU) in communication with a memory system and an interface bus. The CPU is configured to execute instructions stored as a program in the memory system, and send and receive signals to/from the interface bus. The memory system may include various storage types including optical storage, magnetic storage, solid state storage, and other non-volatile memory. The interface bus may be configured to send, receive, and modulate analog and/or digital signals to/from the various sensors and control devices. The program may embody the methods disclosed herein, allowing the CPU to carryout out the steps of such methods and control the ICE 110, Instead of an ECU 450, the automotive system 100 may have a different type of processor to provide the electronic logic, e.g. an embedded controller, an onboard computer, or any processing module that might be deployed in the vehicle.

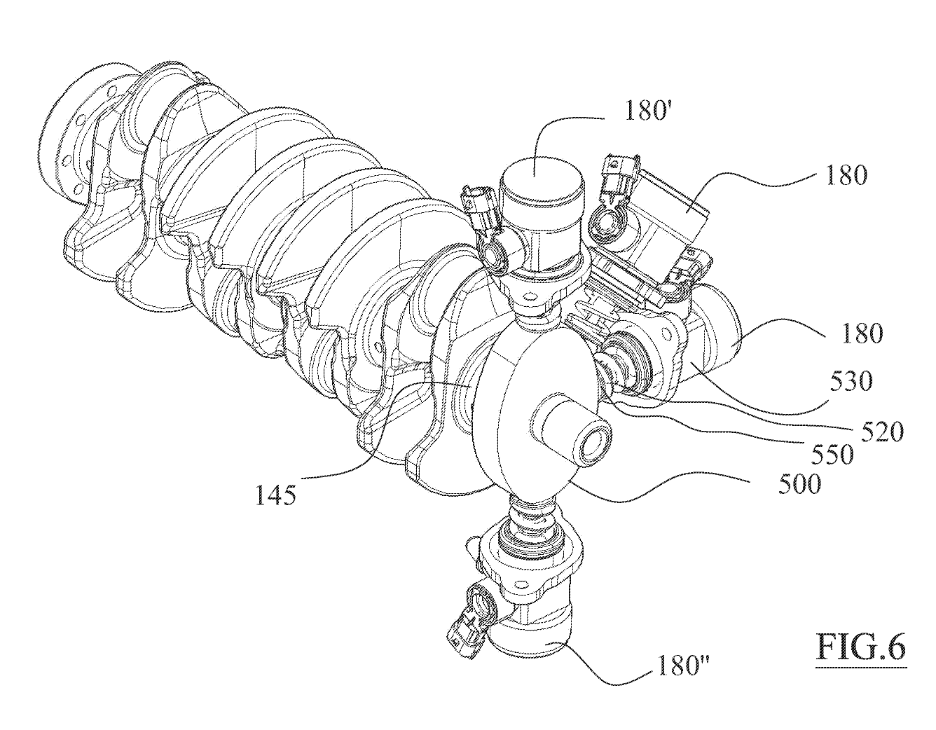

The fuel unit pump 180 includes a plunger 550 (FIG. 6) driven for reciprocal movement within a bore provided in a pump housing 530 (FIG. 6), in order to provide pressure to fuel delivered to the injectors 160. In an embodiment of the present disclosure a fuel rail 170 is in fluid communication with the fuel unit pump 180 to deliver fuel to the injectors 160.

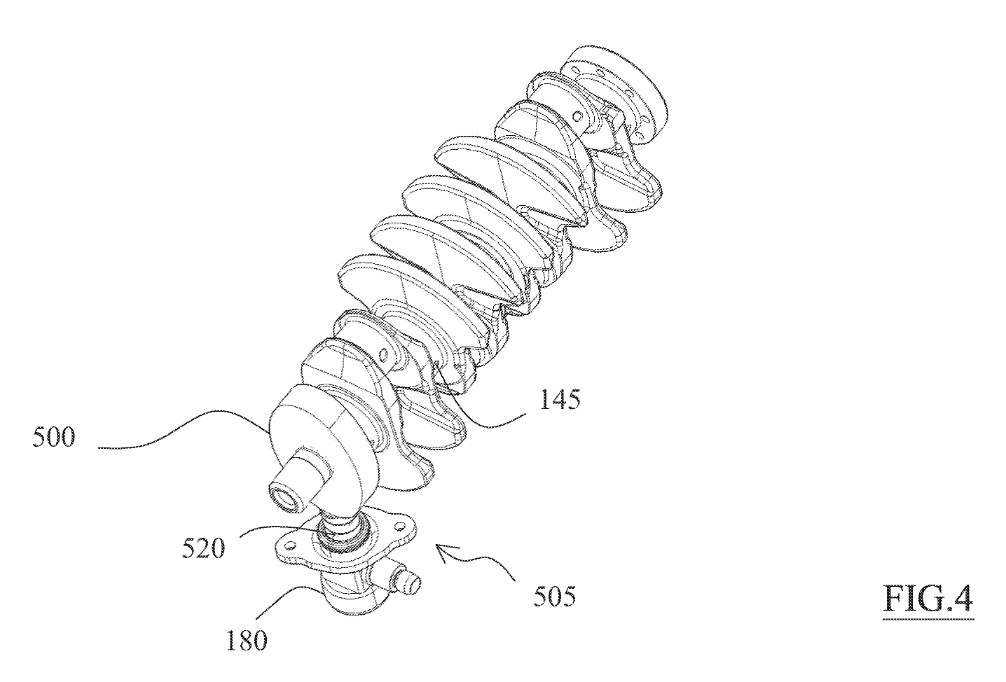

FIG. 3 is a perspective view of a fuel pump assembly 505, according to an embodiment of the present disclosure, the fuel pump assembly 505 including a fuel unit pump 180 driven by a cam 500 press fitted or keyed on the crankshaft 145. The cam 500 press fitted or keyed on the crankshaft 145 of the engine 110 cooperates with a cam follower, such as a roller 510, to deliver a pumping stroke of a plunger 550 during which the fuel is pressurized as the cam 500 rotates along with the crankshaft 145. A return spring 520 maintains the roller 510 in contact with the profile of the cam 500. The cam 500 may be a single lobed or a multi lobed cam. For example, cam 500 may be a bi-lobed or a tri-lobed cam or a four-lobed cam.

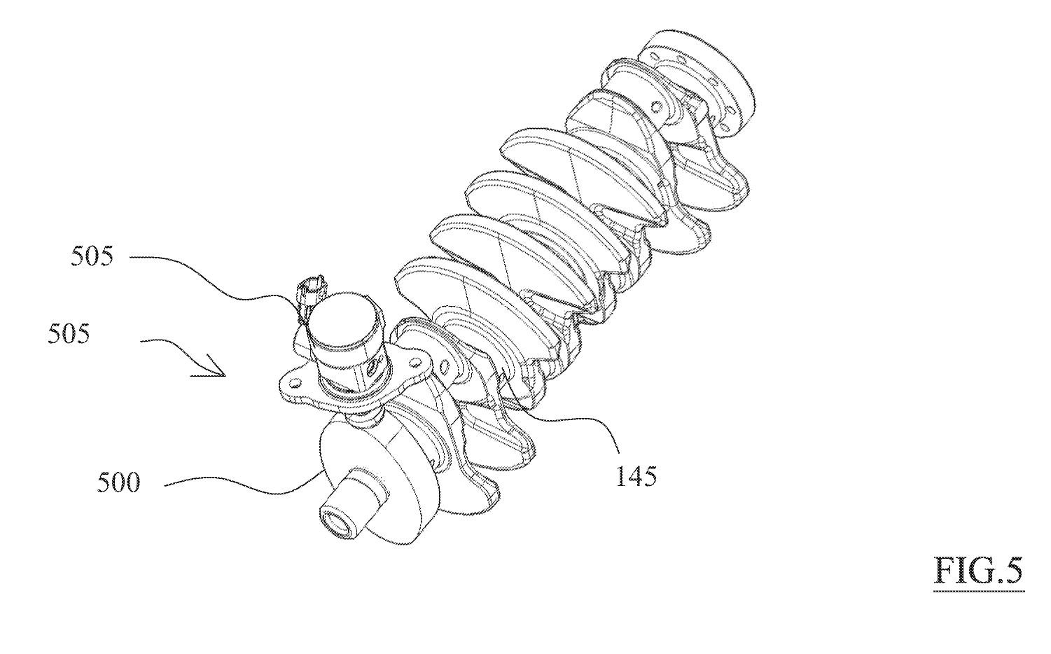

Since the fuel unit pump 180 is closely coupled to the crankshaft 145, it may be positioned on the engine block 120 or, in other embodiments, on the bedplate or inside an oil sump 540 of the engine 110. For example FIG. 3 illustrates a unit pump 180 in a position suitable to be positioned in the bedplate of an internal combustion engine 110; FIG. 4 illustrates a unit pump 180 in a position suitable to be positioned in an oil sump 540 of the engine 110.

FIG. 5 illustrates an embodiment in which a unit pump 180 is positioned in an upper position with respect to the cam 500 inside an interblock of the engine.

FIG. 6 is a perspective view that represents, in a single Figure, various embodiments of the present disclosure. For example, in some embodiments, such as V-engines, two fuel unit pumps 180′, 180″ may be positioned in opposite positions around the engine 110 and be both driven by the same cam 500 on the crankshaft 145.

In an alternative embodiment of the present disclosure, a hydraulic pump for pressurizing oil to be supplied to actuators associated to the engine 110 can be operated in a similar fashion, as described with reference to the fuel unit pump 180. Namely, the hydraulic pump is operated by cam 500 press fitted or keyed on crankshaft 145 and having a suitable number of lobes depending on the application. Cam 500 cooperates with a cam follower of the hydraulic pump to deliver a pumping stroke of the plunger 550 during which oil is pressurized as the cam 500 rotates along with the crankshaft 145.

In the previous description, the values of the various parameters mentioned are intended in an exemplificative and non-limitative way, since different values may be appropriate for different automotive systems, without departing from the various embodiments of the present disclosure.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

What is claimed is:

1. An internal combustion engine (110) comprising one engine cylinder (125) equipped with a piston (140) coupled to rotate a crankshaft (145) and a fluid pump assembly (505) comprising a fluid pump equipped with a pumping plunger (550) for pressurizing fluid, the pumping plunger (550) being driven by a cam (500) press fitted or keyed on the crankshaft (145).

2. An internal combustion engine (110) according to claim 1, wherein the fluid pump is a fuel unit pump (180) for pressurizing fuel to be supplied to a fuel injector (160) for injecting fuel into the cylinder (125).

3. An internal combustion engine (110) according to claim 2, further comprising a fuel rail (170) in fluid communication with the fuel unit pump (180).

4. An internal combustion engine (110) as in claim 1, wherein the fluid pump (180) is located on an engine block (120) on the internal combustion engine (110).

5. An internal combustion engine (110) as in claim 1, wherein the fluid pump (180) is located inside an oil sump (540) of the internal combustion pump engine (110).

6. An internal combustion engine (110) according to claim 1, wherein the fluid pump is an hydraulic pump for pressurizing oil to be supplied to actuators associated to the engine.

7. An internal combustion engine (110) as in claim 1, wherein the cam (500) is a single lobed or a multi lobed cam.

8. An internal combustion engine (110) as in claim 1 and 2, wherein the engine (110 is a V-engine equipped with two fuel unit pumps (180) disposed in opposite positions with respect to the cam (500).

9. A crankshaft (145) for an internal combustion engine (110) comprising one engine cylinder (125) equipped with a piston (140) coupled to rotate the crankshaft (145), the crankshaft (145) being equipped with a cam (500) press fitted or keyed thereon.

10. An internal combustion engine comprising:
an engine having at least one engine cylinder, a piston slidably supported in the cylinder and operable to rotate a crankshaft, and a cam secured to the crankshaft for rotation therewith; and
a fluid pump assembly including a fluid pump having a pumping plunger driven by the cam for pressurizing a fluid.

11. The internal combustion engine according to claim 10 wherein the cam is press fitted or keyed on the crankshaft.

12. The internal combustion engine according to claim 10, further comprising a fuel injection system having a fuel injector for injecting fuel into the cylinder, wherein the fluid pump is a fuel unit pump for pressurizing fuel to be supplied to the fuel injector.

13. The internal combustion engine according to claim 12, wherein the engine comprises a at least one pair of engine cylinders arranged as a V-engine, a piston slidably supported in each cylinder and operable to rotate the crankshaft, and the fluid pump assembly includes two fuel unit pumps disposed in opposite positions with respect to the cam.

14. The internal combustion engine according to claim 12, wherein the fuel injection system further comprises a fuel rail in fluid communication with the fuel unit pump.

15. The internal combustion engine as in claim 10, wherein the engine further comprises an engine block and the fluid pump is located on the engine block.

16. The internal combustion engine as in claim 10, wherein the engine further comprises an oil sump and the fluid pump is located inside the oil sump.

17. The internal combustion engine according to claim 10, wherein the engine further comprises a hydraulic actuator associated to the engine and the fluid pump is a hydraulic pump for pressurizing oil to be supplied to the hydraulic actuator.

18. The internal combustion engine as in claim 1, wherein the cam is a single-lobed cam.

19. The internal combustion engine as in claim 1, wherein the cam comprises a multi-lobed cam.

20. A crankshaft for an internal combustion engine of the type having at least one engine cylinder equipped with a piston coupled to rotate the crankshaft, the crankshaft being equipped with a cam secured to the crankshaft for rotation therewith.

21. The internal combustion engine according to claim 21 wherein the cam is press fitted or keyed on the crankshaft.
